(19) United States
(12) Patent Application Publication
(10) Pub. No.: US 2006/0268502 A1
(43) Pub. Date: Nov. 30, 2006

(54) PORTABLE COMPUTER

(76) Inventors: Zhi-Gang Liu, Shenzhen (CN); Hsuan-Chen Chen, Shenzhen (CN); Ke-Cheng Lin, Shenzhen (CN); Chien-Li Tsai, Shenzhen (CN); Wen-Kang Lo, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/307,048

(22) Filed: Jan. 20, 2006

(30) Foreign Application Priority Data
May 28, 2005 (CN) 200520059237.3

(51) Int. Cl. G06F 1/16

(52) U.S. Cl. 361/683

(57) ABSTRACT

A cover mounting assembly includes a button (20), a cover (40), a locking member (60) and a base plate (70). The cover includes a pair of hooks (49). The locking member includes a lockpin (65). The locking member is attached with the button on the opposite surfaces of the cover to slide forward or rearward together. The base plate includes an opening (71) and a pair of slots (77). The cover is received in the opening of the base plate and the hooks are received in the slots of the base plate respectively. The lockpin of the locking member abuts against the internal surface of the base plate to fasten the cover to the base plate.

### FIELD OF THE INVENTION

The present invention relates to a portable computer, and more particularly to a portable computer which includes a base plate and a motherboard replaced expediently.

### DESCRIPTION OF RELATED ART

Portable computers, such as laptop computers and notebook computers, have become increasingly popular for general use. Generally, a motherboard is directly attached to a base plate of a portable computer, and a plurality of interfaces of connecters and openings of storage devices are formed in side walls of the base plate. As shown in FIG. 5, the portable computer includes a base unit 3 and a cover unit 4. The base unit 3 includes a base plate 31 and a top plate 39. A motherboard 35 is received in the base unit 3. The base plate 31 forms a rectangular bottom wall 32, and a plurality of side walls 34 extends from edges of the bottom wall 32. A plurality of interfaces 341 of connecters and openings 343 of storage devices mating with the motherboard 35 are formed in one or more of the side walls 34. A plurality of protruding posts 311 with threaded holes protrudes from the bottom wall 32. The motherboard 35 defines a plurality of through holes 351 corresponding to the protruding posts 311 respectively. A plurality of screws 37 extends through the through holes 351 of the motherboard 35 and then engages in the threaded holes of the protruding posts 311 respectively, thus the motherboard 35 is attached to the base plate 31. The top plate 39 covers the base plate 31, thus the base unit 3 is assembled. Then the cover unit 4 is pivotally connected to a rear portion of the base unit 3 and the portable computer is assembled. However, to replace the motherboard 35, the base plate 31 have to be replaced for providing interfaces 341 and openings 343 mating with a different motherboard. And also, to replace the base plate 31 for aesthetic feeling, a user has to take out the top plate 39 from the base plate 31, and unscrew the motherboard 35 to separate the base plate 31. The process inconveniences the user and the motherboard 35 takes a risk of being damaged.

What is desired, therefore, is a portable computer which includes a base plate and a motherboard replaced expediently.

### SUMMARY OF INVENTION

In one preferred embodiment, a portable computer includes a base unit and a cover unit. The base unit includes a base plate, a framework, a top plate and a motherboard. The motherboard is attached to the framework. The framework is detachably attached to the base plate, and the top plate covers the framework. A plurality of interfaces and openings mating with the motherboard are formed in side walls of the framework. The cover unit is pivotally connected to a rear portion of the base unit.

The interfaces and the openings mating with the motherboard are formed in the framework, thus only the framework is replaced together with the motherboard and the base plate is retained. The motherboard is attached to the framework, thus the base plate is replaced freely and easier for aesthetic feeling.

Other advantages and novel features will become more apparent from the following detailed description of preferred embodiments when taken in conjunction with the accompanying drawings, in which:

### BRIEF DESCRIPTION OF DRAWINGS

FIG. 1 is an exploded, isometric view of a portable computer with a base unit in accordance with a preferred embodiment of the present invention;

FIGS. 2 and 3 are isometric views showing the assembly process of the base unit;

FIG. 4 is an assembled view of FIG. 1; and

FIG. 5 is an exploded, isometric view of a conventional portable computer.

### DETAILED DESCRIPTION

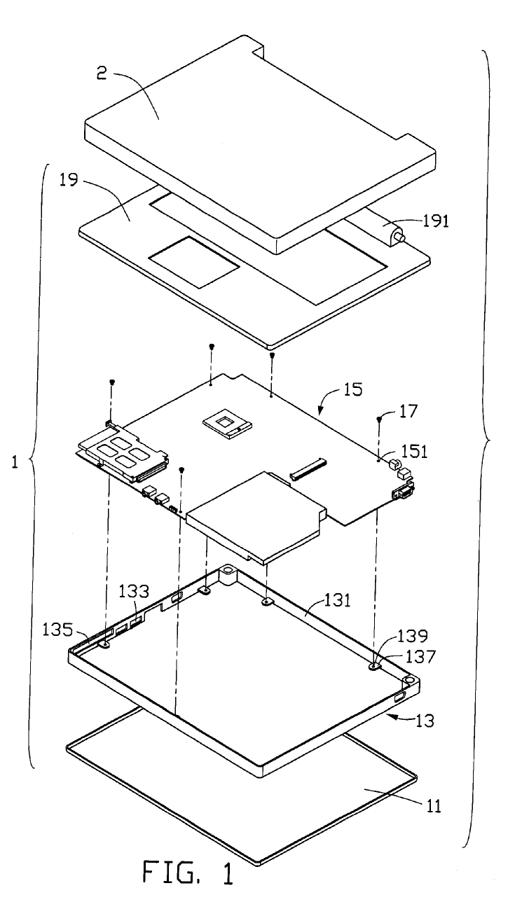

Referring to FIG. 1, a portable computer in accordance with a preferred embodiment of the present invention includes a base unit 1, and a cover unit 2 pivotally connected to a rear portion of the base unit 1. The base unit 1 includes a base plate 11, a framework 13 attached to the base plate 11, and a top plate 19 engaging to the framework 13. A motherboard 15 is received in the base unit 1.

The framework 13 is a rectangular frame with four side walls 131. A plurality of interfaces 133 of connecters and openings 135 of storage devices are formed in one or more side walls 131 of the framework 13. A plurality of tabs 137 is protruded from internal surfaces of the side walls 131 of the framework 13, and each tab 137 defines a threaded hole 139. The tabs 137 are used for supporting and attaching the motherboard 15 and other electronic components.

A plurality of through hole 151 is defined in and adjacent edges of the motherboard 15 corresponding to the threaded holes 139 of the framework 13.

The top plate 19 includes a pivoting portion 191 at a rear end thereof.

The base plate 11 and the top plate 19 are quadrate plate, and have similar structures and functions to the existing technology and the present embodiment do not to describe them in details.

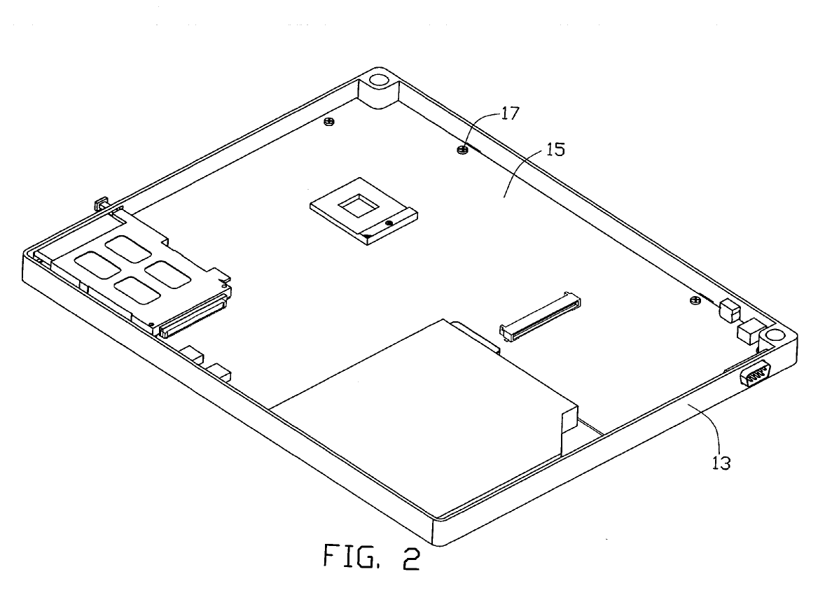

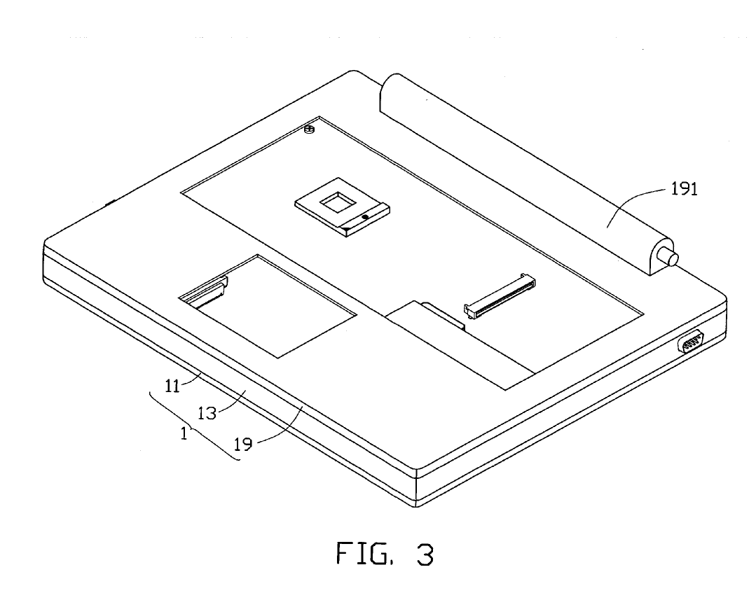

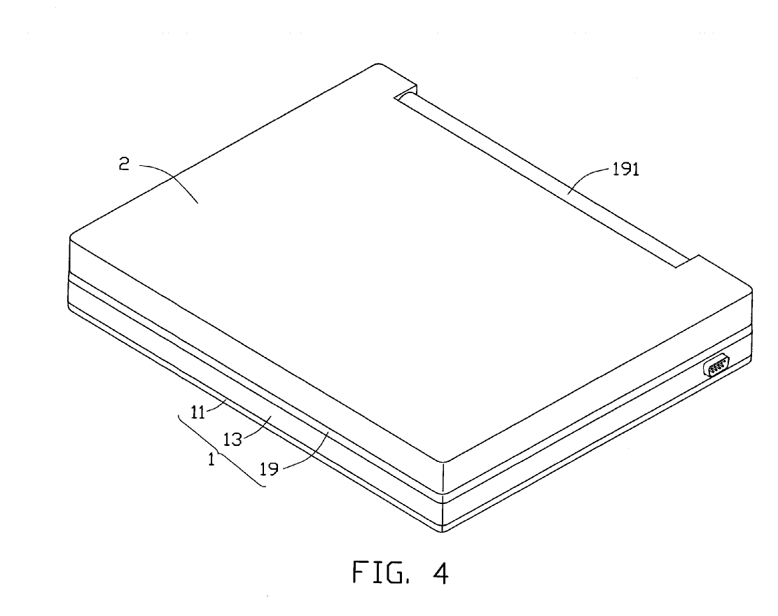

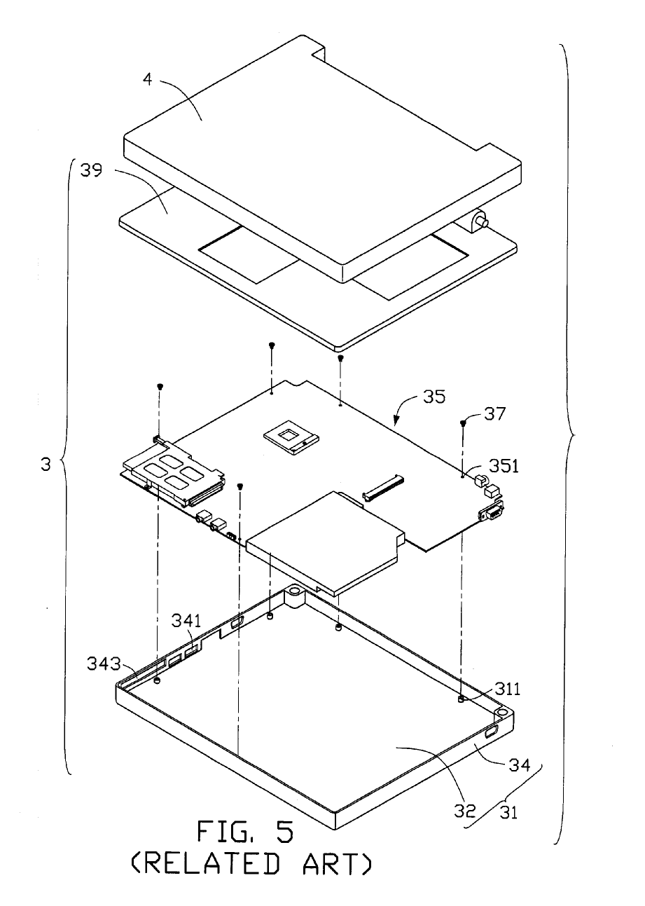

As shown in FIGS. 2 and 3, in assembly, a plurality of screws 17 extends through the through holes 151 of the motherboard 15 and then engages in the threaded holes 139 of the framework 13 respectively, thus the motherboard 15 is attached to the framework 13. The base plate 11 engages to the framework 13, the top plate 19 covers the framework 13, thus the base unit 1 is assembled. The cover unit 2 is pivotally connected to the pivoting portion 191 of the top plate 19. FIG. 4 shows an assembled view of the portable computer. The interfaces 133 and the openings 135 mating with the motherboard 15 are formed in the framework 13, thus only the framework 13 is replaced together with the motherboard 15 and the base plate 11 is retained. The motherboard 15 is attached to the framework 13, thus the base plate 11 is replaced freely and easier for aesthetic feeling.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment.

What is claimed is:

1. A portable computer comprising:
a base unit comprising a base plate, a framework being detachably attached to the base plate, a top plate covering the framework, and a motherboard attached to the framework, wherein a plurality of interfaces and openings mating with the motherboard are formed in side walls of the framework; and
a cover unit pivotally connected to a rear portion of the base unit.

2. The portable computer as claimed in claim 1, wherein the framework comprises a plurality of tabs used for supporting and attaching the motherboard.

3. The portable computer as claimed in claim 2, wherein each of the tabs defines a threaded hole, a plurality of through holes is defined in the motherboard corresponding to the threaded holes of the framework, and a plurality of screws extends through the through holes of the motherboard and engages in the threaded holes of the framework respectively.

4. The portable computer as claimed in claim 1, wherein the top plate includes a pivoting portion at a rear end thereof, and the cover unit is pivotally connected to the pivoting portion of the top plate.

5. A portable computer comprising:
a base unit comprising a base plate, a top plate, and a framework engaging between the base plate and top plate, the framework used for supporting and attaching electronic components of the portable computer and forming interfaces and openings mating with the electronic components; and
a cover unit pivotally connected to a rear portion of the base unit.

6. The portable computer as claimed in claim 5, wherein the electronic component is a motherboard attached to the framework.

7. The portable computer as claimed in claim 6, wherein the framework comprises a plurality of tabs used for supporting and attaching the motherboard.

8. The portable computer as claimed in claim 7, wherein each of the tabs defines a threaded hole, a plurality of through holes is defined in the motherboard corresponding to the threaded holes of the framework, and a plurality of screws extends through the through holes of the motherboard and engages in the threaded holes of the framework respectively.

9. The portable computer as claimed in claim 5, wherein the top plate includes a pivoting portion at a rear end thereof, and the cover unit is pivotally connected to the pivoting portion of the top plate.
